(19) United States
(12) Patent Application Publication
(10) Pub. No.: US 2025/0331679 A1
(43) Pub. Date: Oct. 30, 2025

(54) MULTI-FUNCTIONAL OVEN WITH AIR FRYER CAPABILITY

(71) Applicant: Hamilton Beach Brands, Inc., Glen Allen, VA (US)

(72) Inventors: Suzanne Hensley, Glen Allen, VA (US); Seth Lichtman, Glen Allen, VA (US); Lynda Musante, Glen Allen, VA (US); Drew Carlson, Glen Allen, VA (US); George Stamper, Glen Allen, VA (US); Zachary Rios, Glen Allen, VA (US); John Barnes, Glen Allen, VA (US)

(73) Assignee: Hamilton Beach Brands, Inc., Glen Allen, VA (US)

(21) Appl. No.: 18/644,973

(22) Filed: Apr. 24, 2024

(51) Int. Cl. A47J 37/06; A47J 36/32; F24C 7/06; F24C 15/32

(52) U.S. Cl. CPC A47J 37/0641; A47J 36/32; F24C 7/067; F24C 15/322

(57) ABSTRACT

A multi-functional oven includes: a housing; a door attached to the housing, the door configured to move between an open position and a closed position, wherein in the closed position the housing and the door define an enclosed cooking cavity, and in the open position the door is positioned above the housing to provide access to the cooking cavity; a fan positioned within the housing outside of the cooking cavity, the fan positioned and configured to circulate air within the cooking cavity; a rotation assembly mounted in the housing configured to rotate a pan positioned in the cooking cavity about a vertical axis of rotation; a heating element positioned in the cooking cavity; and a controller operatively connected with the fan, the rotation assembly, and the heating element, the controller configured to selectively operate each of the fan, the rotation assembly, and the heating element.

### FIELD OF THE INVENTION

The present invention is directed generally to cooking appliances, and more specifically to multi-functional cooking appliances.

### BACKGROUND

Various ovens exist for heating and cooking a variety of food items. For example, convection ovens, which are used to cook a variety of foods, rely on circulated heated air to cook foods residing within the oven. Heating elements are typically positioned in the path of the circulating air, which is then directed into the cooking cavity of the oven.

As another example, air fryers are a relatively new innovation in home cooking. Traditionally, deep fat fryers have been used to cook French fries and numerous other food products (e.g., chicken, fish, onion rings). These food products can be prepared from frozen, refrigerated, ambient, or above ambient temperature conditions. Some consumers place a high value on healthier foods that are prepared using less oils or fats, and the replacement of the deep fat frying process with air frying eliminates a significant amount of oil and fat absorption into the food product. But, while consumers desire healthier foods prepared with less fat and oil, they still desire the taste, texture and mouth feel associated with the deep fat frying process. Consumers also seek fast and convenient cooking.

It may be desirable to provide a single appliance that is capable of both typical convection oven and air fryer functionality, and in doing so provide the crispness, texture, speed or convenience typically associated with each cooking method.

### SUMMARY

As a first aspect, embodiments of the invention are directed to a multi-functional oven. The oven comprises: a housing; a door attached to the housing, the door configured to move between an open position and a closed position, wherein in the closed position the housing and the door define an enclosed cooking cavity, and in the open position the door is positioned above the housing to provide access to the cooking cavity; a fan positioned within the housing outside of the cooking cavity, the fan positioned and configured to circulate air within the cooking cavity; a rotation assembly mounted in the housing configured to rotate a pan positioned in the cooking cavity about a vertical axis of rotation; a heating element positioned in the cooking cavity; and a controller operatively connected with the fan, the rotation assembly, and the heating element, the controller configured to selectively operate each of the fan, the rotation assembly, and the heating element.

As a second aspect, embodiments of the invention are directed to an oven comprising: a housing; a door attached to the housing, the door configured to move between a closed position and an open position, wherein in the closed position the housing and the door define an enclosed cooking cavity, and in the open position the door is positioned above the housing to provide access to the cooking cavity; a fan positioned within the housing outside of the cooking cavity, the fan positioned and configured to circulate air within the cooking cavity; a heating element positioned in the cooking cavity; a controller operatively connected with the fan and the heating element, the controller configured to selectively operate the fan and the heating element; a first pan positioned in the cooking cavity, the first pan having a generally horizontal first floor; and a second pan positioned to overlie the first pan, the second pan having a generally horizontal second floor, the second floor being perforated, wherein a gap is present between the first and second floors.

As a third aspect, embodiments of the invention are directed to an oven comprising: a housing; a door attached to the housing, the door configured to move between a closed position and an open position, wherein in the closed position the housing and the door define an enclosed cooking cavity, and in the open position the door is positioned above the housing to provide access to the cooking cavity; a first heating element positioned in an upper portion of the cooking cavity; a second heating element positioned in a lower portion of the cooking cavity, and a controller operatively connected with the first and second heating elements, the controller configured to selectively operate each of the first and second heating element. The first heating element extends most of a width of the cooking cavity, and the second heating element extends most of the width of the cooking cavity.

### BRIEF DESCRIPTION OF THE FIGURES

FIG. 1 is a front perspective view of a multi-functional oven with air frying capability according to embodiments of the invention.

FIG. 2 is a front perspective view of the oven of FIG. 1 with the door in the open position and the air fryer and baking pans removed.

FIG. 3 is a greatly enlarged view of one hinge used to control movement of the door of the oven of FIG. 1, with the door shown in the closed position.

FIG. 4 is a greatly enlarged view of the hinge of FIG. 3, with the door shown in the open position.

FIG. 5 is a front perspective view of the oven of FIG. 1 with the door removed and the air fryer and baking pans present in the cooking cavity.

FIG. 6 is a front view of the oven of FIG. 1 with the door removed and the air fryer and baking pans present.

FIG. 7 is a front, top perspective view of the oven of FIG. 1 with the door removed and the air fryer pan absent.

FIG. 8 is a front, top view of the oven of FIG. 1 with the door removed and both the air fryer pan and baking pan absent.

FIG. 9 is a front, side perspective view of the oven of FIG. 1 with the door and rear cavity wall removed and the air fryer pan and baking pan absent.

FIG. 10 is a side view of the oven of FIG. 1 with the door removed.

FIG. 11 is a side section view of the oven of FIG. 1 with the door removed and the air fryer and baking pans absent.

FIG. 12 is a side perspective section view of the oven of FIG. 1 with the baking and air fryer pans present.

FIG. 13 is a top perspective view of the air fryer pan and the baking pan of the oven of FIG. 1.

FIG. 14 is a bottom perspective view of the baking pan, air fryer pan and lower heating element of the oven of FIG. 1.

FIG. 15 is a top perspective view of the air fryer pan of the oven of FIG. 1.

FIG. 16 is a top perspective view of the baking pan of the oven of FIG. 1.

FIG. 17 is a rear top perspective view of the air duct of the oven of FIG. 1.

FIG. 18 is a top perspective view of the oven of FIG. 1 with the cover of housing removed and the door largely shown in broken line to indicate the air circulation path during air frying.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

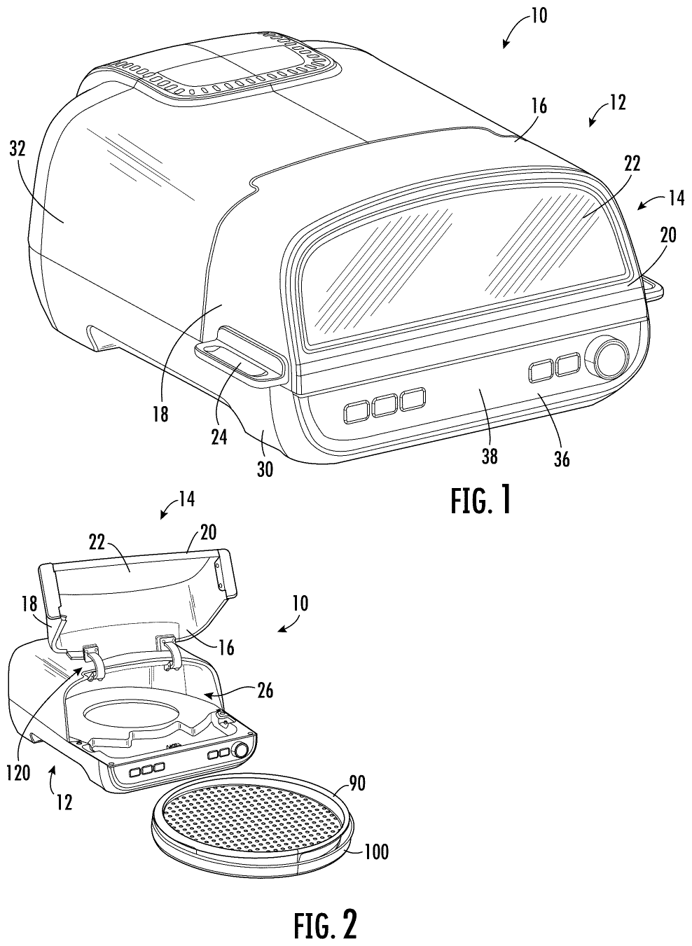

Referring now to the drawings, a multi-functional oven, designated broadly at 10, is shown in FIG. 1. The oven 12 includes a housing 12 and a door 14 that is pivotally attached near its upper edge to the front edge of a ceiling 16 of the housing 12. The door 14 includes side walls 18 that merge with the ceiling 16, and a front wall 20 that includes a clear window 22. Handles 24 extend laterally from the lower portions of the side walls 18. As shown in FIGS. 1 and 2, the door 14 can pivoted between a closed position (FIG. 1), in which the window 22 faces forwardly and the door 14 meets with the remainder of the housing 12 to enclose a cooking cavity 26, and an open position (FIG. 2), in which the window 22 faces upwardly and the cooking cavity 26 is not enclosed, thereby providing access thereto.

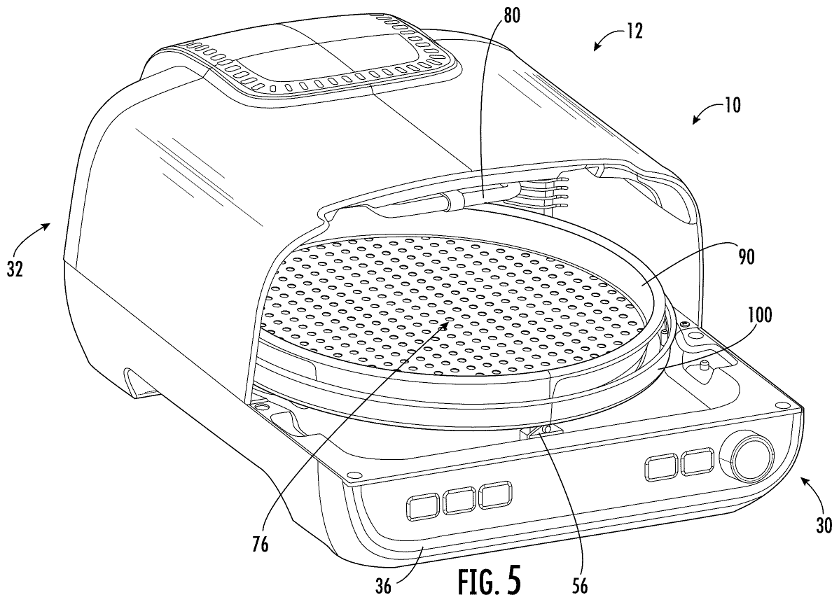

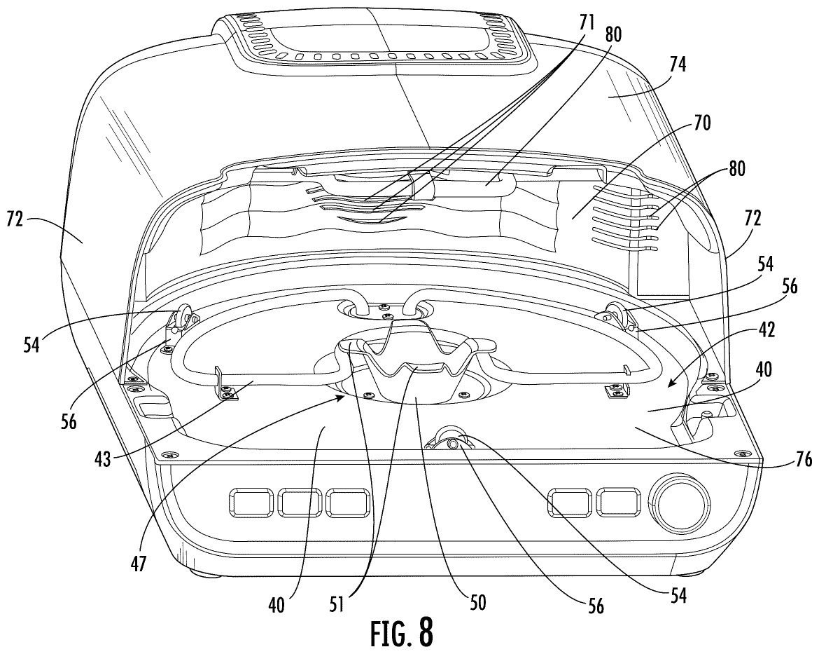

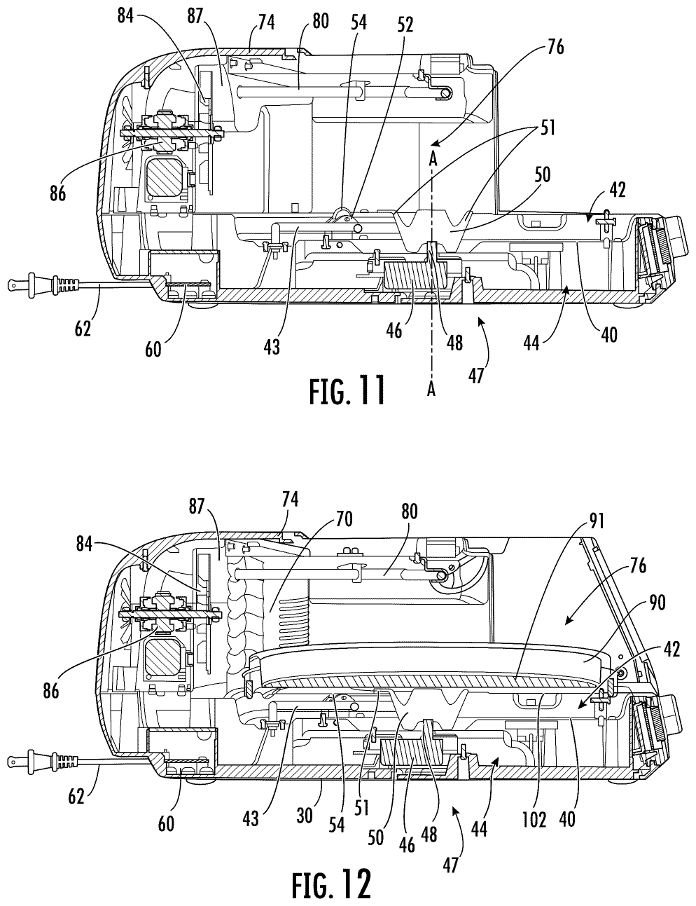

Referring to FIGS. 5-8, the housing 12 includes a base 30 and an upper cover 32. The base 30 is generally rectangular and includes a front wall 36 on which a control panel 38 with various buttons, knobs, etc. is mounted. A cavity floor 40 provides the upper surface of the base 30 and defines a base chamber 44 with the remainder of the base 30. The cavity floor 40 includes a generally circular recess 42 (see also FIGS. 11 and 12). A generally semi-circular lower heating element 43 is mounted in the rear portion of the recess 42 (see FIGS. 8, 11 and 12). The lower heating element 43 extends across much, if not most, of the recess 42, as well as being routed just radially inwardly of the rear half of the recess 42 (see FIG. 8).

Referring now to FIGS. 8, 11 and 12, a rotation assembly 47 is shown therein. A motor 46 is mounted beneath the recess 42 and includes a shaft 48 that extends upwardly into the recess 42. A pan support 50 with four upwardly-extending prongs 51 is mounted to the upper end of the shaft 48 and resides within a central arc of the lower heating element 43. In addition, and best seen in FIG. 8, three wheels 54 are mounted on the upper surface of the cavity floor 40 within the recess 42 via support brackets 56. The wheels 54 are mounted essentially circumferentially equidistant from each other.

A controller 60 (typically in the form of a PCB) that serves to control the operation of the oven 10 is mounted in the rear portion of the base chamber 44 (FIGS. 11 and 12). A power cord 62 is operatively connected with the PCB 60. The PCB 60 is also operatively connected with the motor 46 and the control panel 38.

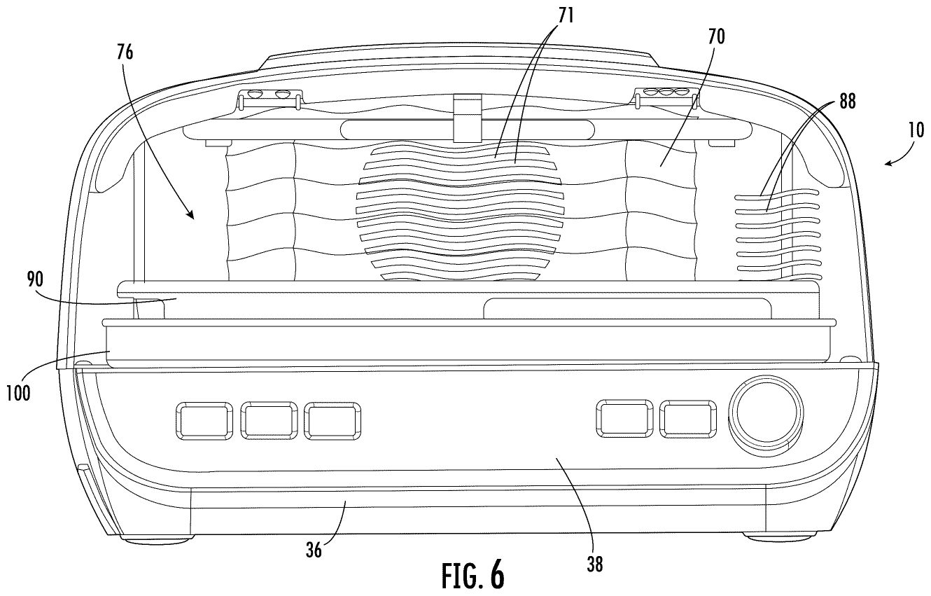

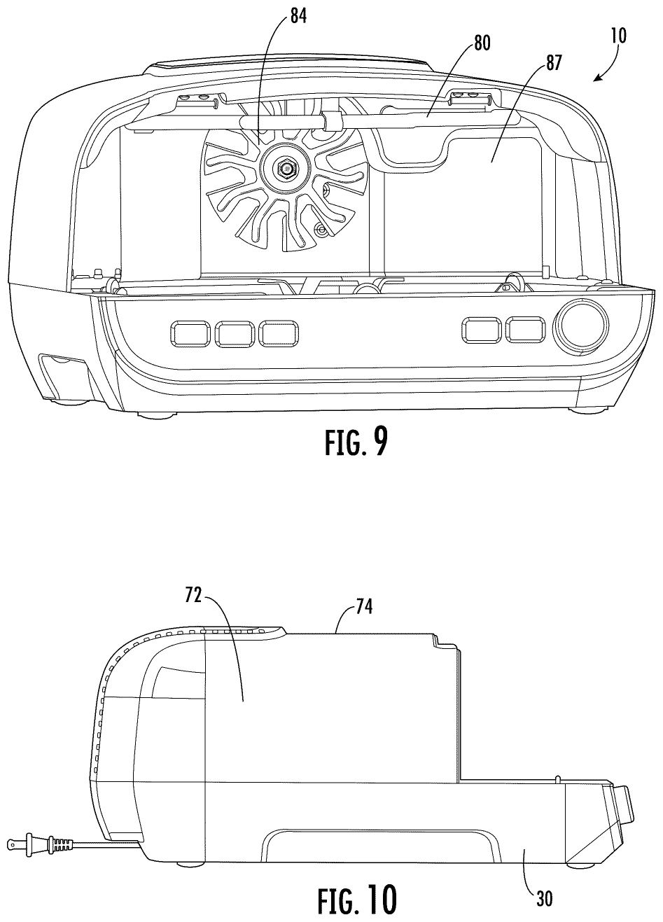

Referring now to FIGS. 6-8 and 12, a rear cavity wall 70 is positioned rearwardly of the recess 42. The rear cavity wall 70 extends laterally to meet the side walls 72 of the upper cover 32, and also extends upwardly to meet the ceiling 74 of the upper cover 32. A cooking cavity 76 is positioned forwardly of the rear cavity wall 70 and is defined by the rear cavity wall 70, the side walls 72, the ceiling 74, the cavity floor 40, and the door 14. As shown in FIGS. 8, 9 and 11, an upper heating element 80 extends forwardly from the rear cavity wall 70 and is positioned just below the ceiling 74. The forwardmost portion of the upper heating element 80 is positioned just rearwardly of the rear edge of the door 14 (and generally above the support 50) extends widthwise to span most of the cooking cavity 76. The upper heating element 80 also extends rearwardly to the rear portion of the cooking cavity 76.

Although the components of the oven 10 may be sized and arranged in any suitable manner, in some embodiments the cooking cavity 76 is configured to be relatively short in height compared to its width and depth. For example, in some embodiments the cooking cavity 76 may be between about 4 and 6 inches in height, while being between about 11 and 14 inches in width and about 11 to 14 inches in depth. In some embodiments, the ratio of the width of the cooking cavity 76 to the height may be between about 1.8:1 and 3.5:1, and/or the ratio of the depth of the cooking cavity 76 to the height may be between about 1.8:1 and 3.5:1. This general shape may be advantageous for baking certain flat foodstuffs, such as pizza, flatbreads, cookies, pies, and the like, although other non-flat foodstuffs, such as chicken breasts or drumsticks, brussels sprouts, may also be suitable for cooking in the oven 10.

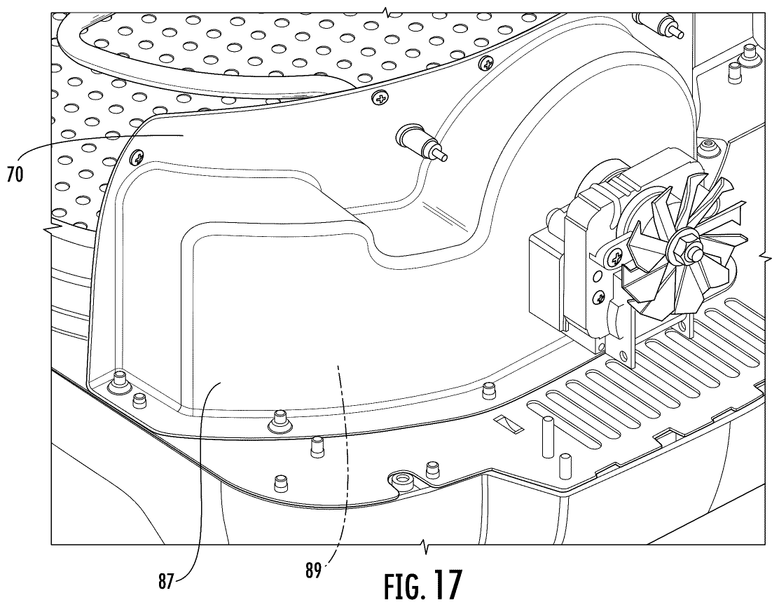

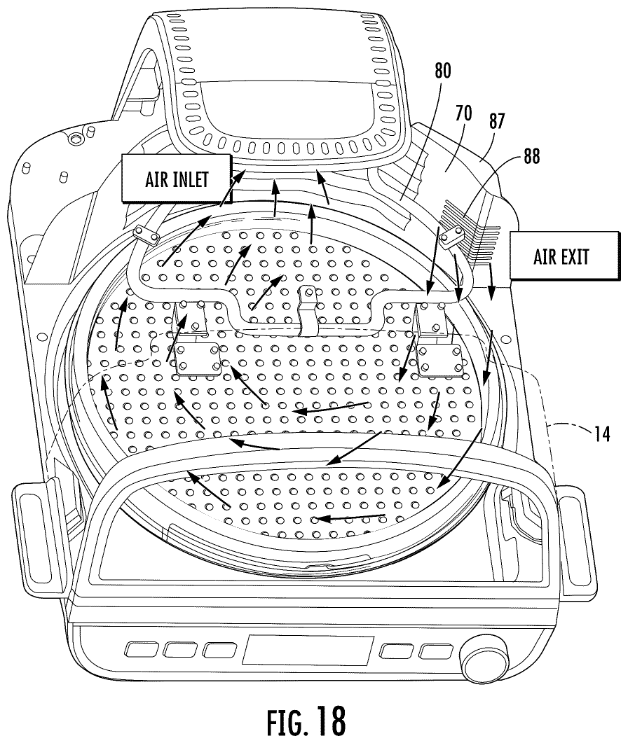

As shown in FIGS. 11 and 12, a fan 84 is mounted rearwardly of the rear cavity wall 70 and is oriented to force air through vents 71 in the rear cavity wall 70 into the cooking cavity 76. A motor 86 is attached to the fan 84. The motor 86 is operatively connected with the PCB 60. A shroud 87 (best seen in FIG. 17) is disposed between the fan 84 and the motor 86 and extends along one side of the rear cavity wall 70 to form a fan duct 89. Vents 88 (see FIGS. 6-8 and 18) are located near the front end of the shroud 87 so that air can be forced by the fan 84 from the duct 89 into the cooking cavity 76.

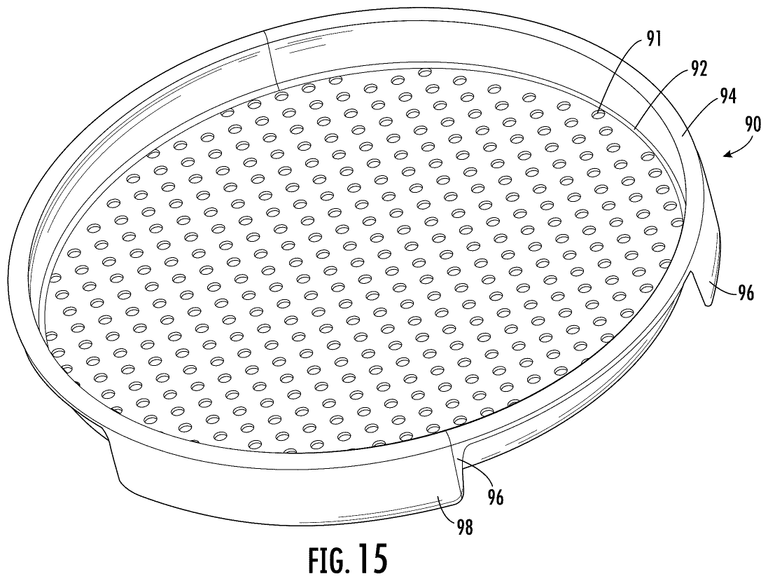

Referring now to FIG. 15, a perforated air fryer pan 90 is shown therein. The air fryer pan 90 includes a floor 91 with holes 92 surrounded by a peripheral rim 94. The air fryer pan 90 is typically between about 10 and 13 inches in diameter and/or between about 0.25 and 1 inch in depth. The holes 92 enable air to flow around food positioned on the perforated pan, rendering it suitable for air frying. Three supports 96, each extending circumferentially about 60 degrees about the periphery, project downwardly from the rim 94. The supports 96 are encased in jackets 98, which typically are formed of silicon or another non-abrasive material. The air fryer pan 90 is typically coated with a non-stick surface.

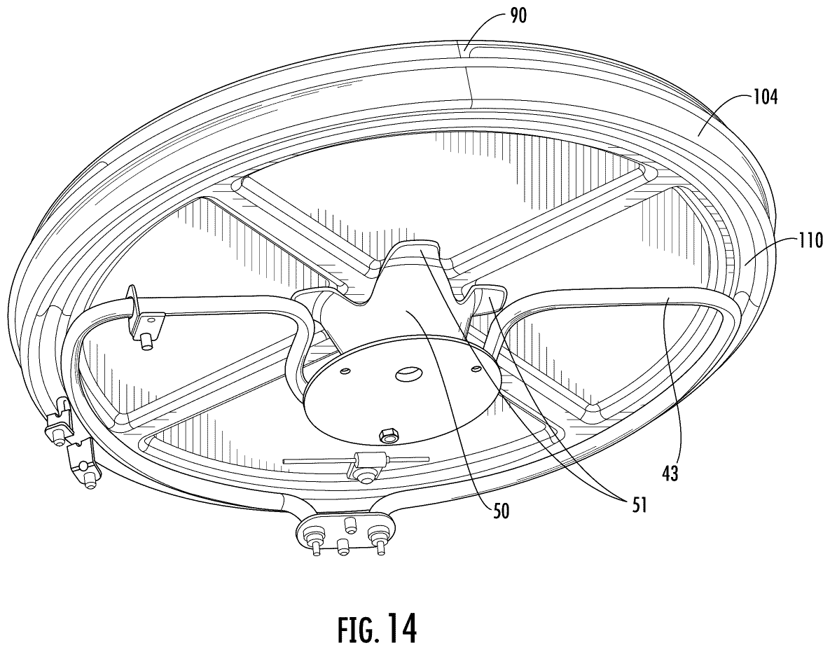

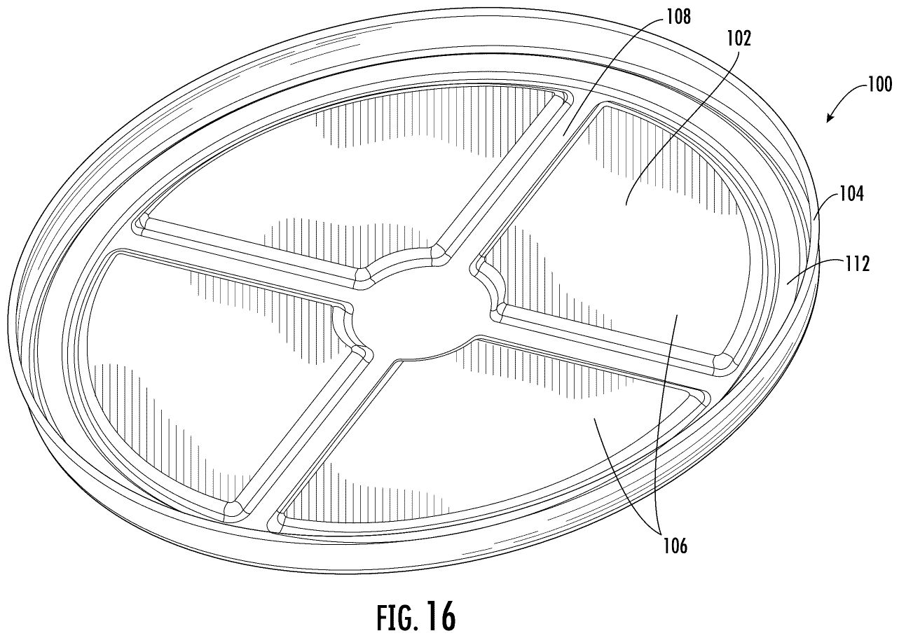

Referring now to FIG. 16, a baking pan 100 is shown therein. The baking pan has a solid floor 102 and a raised peripheral rim 104. The floor 102 is divided into raised quadrants 106 that are separated by shallow channels 108. A downwardly-facing circumferential groove 110 (see FIG. 14) is located near the rim 104. An upwardly facing groove 112 is located radially outwardly for the groove 110. The baking pan 100 is slightly larger in diameter than the air fryer pan 90; as an example, the baking pan 100 be between about 10 and 13 inches in diameter. Like the air fryer pan 90, the baking pan 100 is typically coated with a non-stick surface.

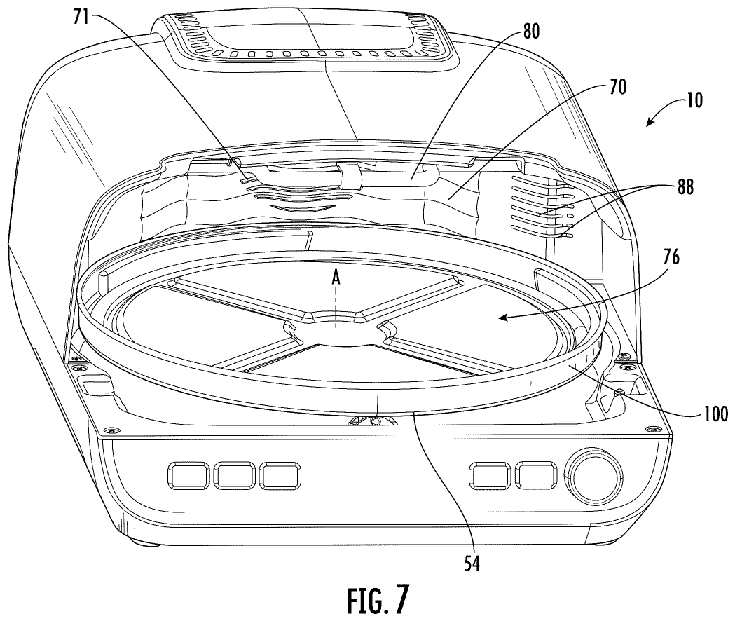

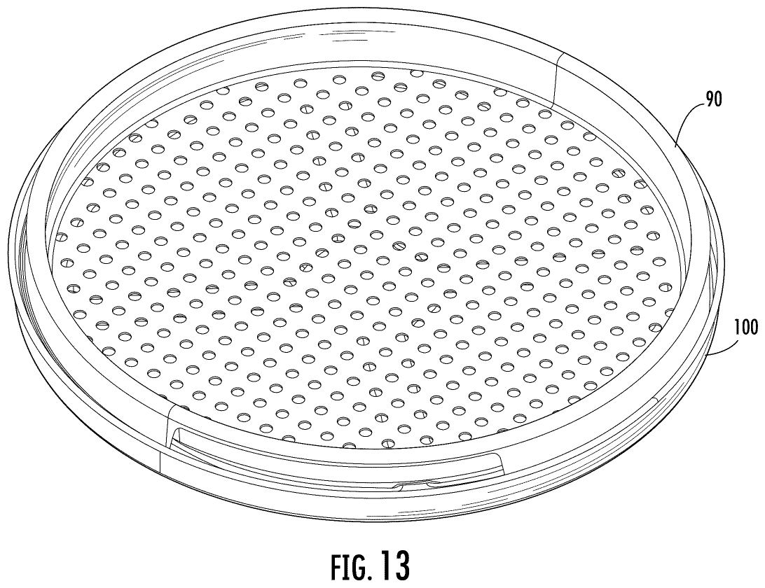

As can be seen in FIG. 7, the baking pan 100 is positioned within the cooking cavity 76 such that the wheels 54 are received in the circumferential groove 110. Also, the prongs 51 of the pan support 50 are positioned at the radially-inward section of the quadrants 106 of the baking pan 100 (see FIG. 12). As shown in FIG. 13, the air fryer pan 90 may be positioned on the baking pan 100 such that the supports 96 are received in the upwardly facing groove 112; the jackets 98, which are typically formed of a non-abrasive material, protection the non-stick surface of the baking pan 100. Such positioning raises the floor 91 of the air fryer pan 90 above the floor 102 of the baking pan 100 so that a gap exists therebetween, thereby allowing air to circulate between the floors 91, 102 and to flow through the holes 92 in the air fryer pan 90 (FIG. 12).

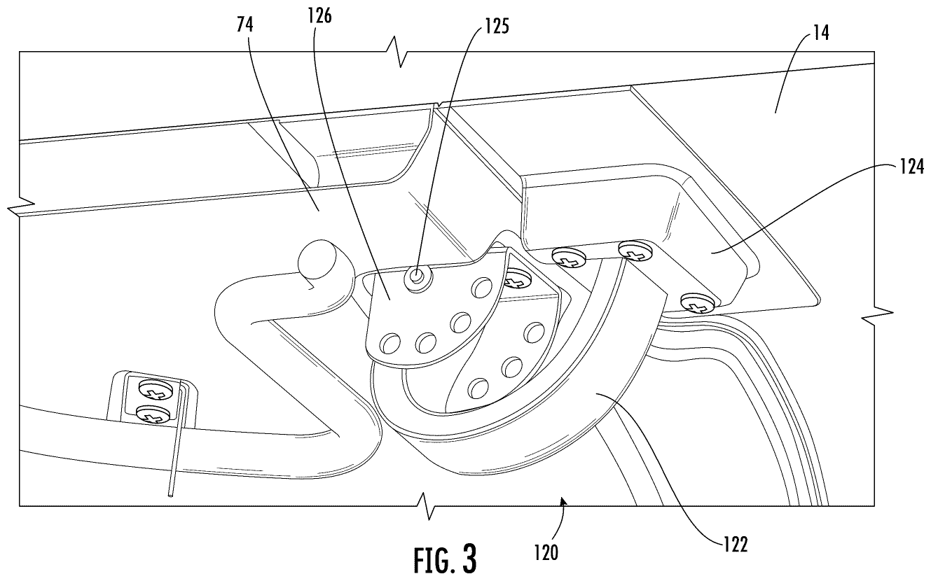

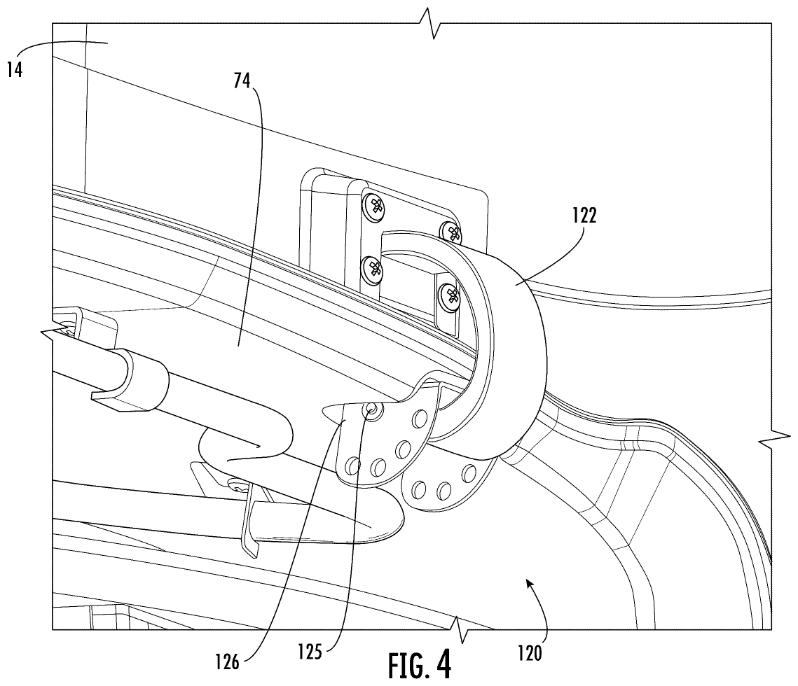

Referring now to FIGS. 3 and 4, shown therein are enlarged views of one of two hinges 120 that enable the door 14 to pivot relative to the housing 12. As shown in FIG. 3, the hinge 120 includes an arcuate arm 122 that is fixed at its forward end to the rear edge of the underside of the door 14 via a mounting block 124. At its opposite end, the arm 122 is pivotally mounted via a pin 125 to a bracket 126 that is fixed to the underside of the ceiling 16 of the housing 12. The curvature of the arm 122 enables the rear edge of the door 14 to rise and move rearwardly relative to the housing 12 when the door 14 is moved to the open position (see FIGS. 2 and 4), so that the door 14 is spaced apart from the bousing 12. This positioning of the door 14 can move the door 14 farther rearwardly and upwardly from the cooking cavity 76 to provide the user easier access to the cooking cavity 76.

In operation, if the user wishes to use the appliance 10 for air frying, both the baking pan 100 and the air fryer pan 90 are positioned in the cooking cavity 76 (see FIGS. 5 and 6), with the baking pan 100 resting on the prongs 51 of the pan support 50 and on the wheels 56. The air fryer pan 90 is positioned in the baking pan 100 as described above, with the support 96 in the groove 112. The user places food on the floor 91 of the air fryer pan 90. Because the air fryer pan 90 is relatively wide and shallow compared to typical air fryer baskets, the user can spread out the food over a larger area than is typical (particularly when the food is presented in individual morsels, such as fried potatoes, vegetable chunks, chicken “nuggets” or the like). Spreading out the food (rather than the food being piled on top of itself) can allow more air to reach the surface of the food during cooking, which can both speed up cooking and provide a crispier texture than if the food were piled. In addition, because the food is spread out, there is no need to remove the cooking vessel (i.e., the air fryer pan 90) and shake it to agitate the food, which is often required for air fryer that use a deep basket or other cooking vessel. Forgoing the shaking step is not only more convenient, but also prevents heat from escaping from the cooking cavity 76, which can occur with conventional air fryers.

Once the food is on the air fryer pan 90 and in the cooking cavity 76, the user closes the door 14, selects a cooking mode (presumably air frying) with buttons on the control panel 38, and initiates cooking. In the air frying mode, the controller 60 activates the upper and lower heating elements 80, 43, thereby providing heat inside the housing 12. The controller 60 also activates the motor 46, which causes the pan support 50 to rotate about a vertical axis A (see FIG. 11). The baking pan 100, and in turn the air fryer pan 90, rotate about the vertical axis A while being supported by the wheels 56.

In addition, the controller 60 activates the motor 86, which causes the fan 84 to rotate. Rotation of the fan 84 causes heated air in the cooking cavity 76 to circulate. More specifically, the fan 84 forces air from the fan duct 89 through the vents 71 and into the cooking cavity 76. The air is heated in the cooking cavity 76 by the upper and lower heating elements 80, 43. The air circulates over and around the food positioned on the air fryer pan 90 and may flow through the holes 92 therein. The air is then drawn through the vents 88 in the rear cavity wall 70 and returned in the fan duct 89 to the fan 84 for re-circulation (the air circulation path is shown with arrows in FIG. 18). Notably, the air remains in the cooking cavity 76 and the fan duct 89, and therefore remains heated; the oven 10 does not rely in heating external air, and therefore can provide heated air to the food more efficiently (although in some embodiments, some external air may be drawn into the cooking cavity 76).

If the user wishes to bake food in the appliance 10, the user inserts the baking pan 100 into the cooking cavity 76 and seats it on the pan support 50 and the wheels 56, but without the air fryer pan 90 as described above (see FIG. 7). The user selects a cooking mode (presumably “baking” on the like) with the control panel 38. Upon activation of the appliance 10, the controller 60 activates the upper and lower heating elements, which generate heat in the cooking cavity 76. In addition, the controller 60 activates the motor 46, which causes the baking pan 100 to rotate. However, in some embodiments, the controller 60 does not activate the motor 86, so the fan 84 does not rotate to circulate air through the cooking cavity 76 and the duct 89. Under such circumstances, the oven 10 acts as a conventional oven (as opposed to a convection oven).

In the baking mode, the oven 10 may be employed for the baking of any foodstuff, but in particular the oven 10 may be suitable for the baking of pizza and other flat foodstuffs (e.g., cookies, pies, flatbreads like pita and naan, and the like). Because the upper and lower heating elements 80, 43 are relatively close to the food being cooked, the heat experienced by the food may be quite intense, and therefore the food may bake more quickly than in an over with a taller cooking cavity. Also, the rotation of the baking pan 100 during cooking can ensure that the foodstuff is being cooked evenly, as each part of the foodstuff is rotated directly under the upper heating element 80 and directly over the lower heating element 43 with each rotation of the pan(s).

Also notable is the arrangement of the upper and lower heating elements 80, 43. Because the heating elements 80, 43 extend across most of the width of the cooking cavity 76, as the pans 90, 100 rotate, the food heats relatively evenly (i.e., both the center of the pans 90, 100 and the edges of the pans 90, 100 receive heat as the pans 90, 100 rotate. As a result, a desired texture for certain foods can be achieved (e.g., cheese on pizza may melt, but not become overcooked and crisp).

Those of skill in this art will appreciate that the oven 10 may take other forms. For example, in some embodiments, when using the baking mode, the fan 84 may operate, so that the oven 10 operates much like a convection oven. Also, in some embodiments, the fan 84 may be configured so that the air flow in the cooking cavity 76 is reversed (i.e., air is drawn from cooking cavity 76 through the vents 71 and returned to the cooking cavity 76 via the vents 88. Other variations may also be employed.

In addition, in some embodiments, the air fryer pan 90 may be configured with its own lower drain shield, such that the baking pan 100 may be omitted. In some embodiments, in either the air frying mode or the baking mode, the user may have the option of the baking pan 100 not rotating. In further embodiments, the rotation assembly 47 may be configured so that the rotation of the baking pan 100 (and in turn the air fryer pan 90 in the air frying mode) may be driven by one or more of the wheels 56 rather than by the support 50. Other variations may also be employed.

It should also be noted that the door 14 may open in a different manner. For example, the door may pivot around a vertical axis (i.e., it may be hinged on a side edge rather that the upper edge), or there may be two doors, each pivoting about a vertical axis in the manner of French doors. Other configurations may be employed.

In addition, the controller 60 may be configured in different ways. For example, the controller 60 may be programmable, such that it initiates cooking only after a predetermined delay or at a particular time, or such that it discontinues cooking after a set period. The controller 60 may also be configured to communicate with a remote device (via Wifi, Bluetooth, or the like), which can provide the user with the ability to activate, deactivate, adjust, etc. the appliance from a remote location (e.g., the ingredients may be placed in the appliance in slow cooking mode, then activated remotely by a user to ensure that cooking is completed upon the user's arrival at home).

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. An oven, comprising:
a housing;
a door attached to the housing, the door configured to move between an open position and a closed position, wherein in the closed position the housing and the door define an enclosed cooking cavity, and in the open position the door is positioned above the housing to provide access to the cooking cavity;
a fan positioned within the housing outside of the cooking cavity, the fan positioned and configured to circulate air within the cooking cavity;
a rotation assembly mounted in the housing configured to rotate a pan positioned in the cooking cavity about a vertical axis of rotation;
a heating element positioned in the cooking cavity; and
a controller operatively connected with the fan, the rotation assembly, and the heating element, the controller configured to selectively operate each of the fan, the rotation assembly, and the heating element.

2. The oven defined in claim 1, further comprising a pan positioned to engage and be rotated by the rotation assembly.

3. The over defined in claim 2, wherein the pan is a first pan, and further comprising a second pan mounted on and above the first pan.

4. The oven defined in claim 3, wherein the second pan includes a floor with perforations, and wherein the floor is above and spaced apart from a floor of the first pan.

5. The oven defined in claim 1, wherein the heating element is a first heating element and is mounted at an upper portion of the cooking cavity, and further comprising a second heating element mounted to underlie a pan positioned on the rotation assembly.

6. The oven defined in claim 5, wherein the first heating element extends widthwise for most of a width of the cooking cavity, and the second heating element extends for most of the width of the cooking cavity.

7. The oven defined in claim 1, wherein the rotation assembly comprises a support positioned to engage the pan, the support mounted on the axis of rotation.

8. The oven defined in claim 1, wherein the rotation assembly includes first and second wheels positioned to engage the pan.

9. The oven defined in claim 1, wherein the door is pivotally attached to the housing, and wherein in the open position the door is located above and spaced apart from the housing.

10. The oven defined in claim 1, wherein the fan is positioned within a duct, and wherein the fan is configured to draw air from the cooking cavity into the duct through a first set of vents and to force air from the duct into the cooking cavity through a second set of vents.

11. The oven defined in claim 1, wherein the cooking cavity is between about 4 and 6 inches in height, between about 11 and 14 inches in width, and between about 11 and 14 inches in depth.

12. The oven defined in claim 1, wherein a ratio of a width of the cooking cavity to a height of the cooking cavity is between about 1.8:1 and 3.5:1.

13. The oven defined in claim 1, wherein a ratio of a depth of the cooking cavity to a height of the cooking cavity may be between about 1.8:1 and 3.5:1.

14. An oven, comprising:
a housing;
a door attached to the housing, the door configured to move between a closed position and an open position, wherein in the closed position the housing and the door define an enclosed cooking cavity, and in the open position the door is positioned above the housing to provide access to the cooking cavity;
a fan positioned within the housing outside of the cooking cavity, the fan positioned and configured to circulate air within the cooking cavity;
a heating element positioned in the cooking cavity;
a controller operatively connected with the fan and the heating element, the controller configured to selectively operate the fan and the heating element;
a first pan positioned in the cooking cavity, the first pan having a generally horizontal first floor; and
a second pan positioned to overlie the first pan, the second pan having a generally horizontal second floor, the second floor being perforated, wherein a gap is present between the first and second floors.

15. The oven defined in claim 14, wherein the cooking cavity is between about 4 and 6 inches in height, between about 11 and 14 inches in width, and between about 11 and 14 inches in depth.

16. The oven defined in claim 14, wherein a ratio of a width of the cooking cavity to a height of the cooking cavity is between about 1.8:1 and 3.5:1.

17. The oven defined in claim 14, further comprising a rotation assembly mounted in the housing configured to rotate the first and second pans about a vertical axis of rotation.

18. An oven, comprising:
a housing;
a door attached to the housing, the door configured to move between a closed position and an open position, wherein in the closed position the housing and the door define an enclosed cooking cavity, and in the open position the door is positioned above the housing to provide access to the cooking cavity;
a first heating element positioned in an upper portion of the cooking cavity;
a second heating element positioned in a lower portion of the cooking cavity, and
a controller operatively connected with the first and second heating elements, the controller configured to selectively operate each of the first and second heating element;
wherein the first heating element extends most of a width of the cooking cavity, and the second heating element extends most of the width of the cooking cavity.

19. The oven defined in claim 18, further comprising a rotating assembly for rotating a pan within the cooking cavity about a vertical axis, and wherein each of the first and second heating elements pass through or adjacent to the vertical axis.

20. The oven defined in claim 19, wherein a ratio of a width of the cooking cavity to a height of the cooking cavity is between about 1.8:1 and 3.5:1, and wherein a ratio of a depth of the cooking cavity to a height of the cooking cavity is between about 1.8:1 and 3.5:1.
